(19) United States
(12) Patent Application Publication
(10) Pub. No.: US 2008/0075872 A1
(43) Pub. Date: Mar. 27, 2008

(54) Nanoscopic Assurance Coating for Lead-Free Solders

(76) Inventors: Joseph D. Lichtenhan, Petal, MS (US); Andre Lee, Novi, MI (US); Sukhendu B. Hait, Hattiesburg, MS (US)

Correspondence Address: PILLSBURY WINTHROP SHAW PITTMAN LLP, P.O. BOX 10500, MCLEAN, VA, 22102, US

(21) Appl. No.: 11/839,462

(22) Filed: Aug. 15, 2007

Related U.S. Application Data
(63) Continuation-in-part of application No. 11/420,207, filed on May 24, 2006.
(63) Continuation-in-part of application No. 11/297,041, filed on Dec. 7, 2005.
(63) Continuation-in-part of application No. 11/015,185, filed on Dec. 17, 2004.
(63) Continuation-in-part of application No. 11/354,583, filed on Feb. 14, 2006.
(63) Continuation-in-part of application No. 10/910,810, filed on Aug. 3, 2004.
(63) Continuation-in-part of application No. 11/342,240, filed on Jan. 27, 2006.
(63) Continuation-in-part of application No. 11/225,607, filed on Sep. 12, 2005.
(63) Continuation-in-part of application No. 11/166,008, filed on Jun. 24, 2005, now abandoned.
Application No. 11/166,008 is a continuation of application No. 09/631,892, filed on Aug. 4, 2000, now Pat. No. 6,972,312.
Application No. 11/225,607 is a continuation of application No. 10/351,292, filed on Jan. 23, 2003, now Pat. No. 6,933,345.
Application No. 11/225,607 is a continuation-in-part of application No. 09/818,265, filed on Mar. 26, 2001, now Pat. No. 6,716,919.
Application No. 11/225,607 is a continuation of application No. 09/747,762, filed on Dec. 21, 2000, now Pat. No. 6,911,518.
Application No. 11/225,607 is a continuation of application No. 10/186,318, filed on Jun. 27, 2002, now Pat. No. 6,927,270.
(60) Provisional application No. 60/822,792, filed on Aug. 18, 2006.
(60) Provisional application No. 60/684,415, filed on May 24, 2005.
(60) Provisional application No. 60/634,495, filed on Dec. 8, 2004.
(60) Provisional application No. 60/531,458, filed on Dec. 18, 2003.
(60) Provisional application No. 60/652,922, filed on Feb. 14, 2005.
(60) Provisional application No. 60/648,327, filed on Jan. 27, 2005.
(60) Provisional application No. 60/608,582, filed on Sep. 10, 2004.
(60) Provisional application No. 60/147,435, filed on Aug. 4, 1999.
(60) Provisional application No. 60/351,523, filed on Jan. 23, 2002.
(60) Provisional application No. 60/192,083, filed on Mar. 24, 2000.
(60) Provisional application No. 60/171,888, filed on Dec. 23, 1999.

(51) Int. Cl. C08G 77/00; B05D 3/02

(52) U.S. Cl. 427/387; 528/10

(57) ABSTRACT

Nanoscopic silicon containing agents including polyhedral oligomeric silsesquioxane and polyhedral oligomeric silicate are used to eliminate the formation of conductive metal whiskers at the surface of lead-free solders joints and atom migration in semiconductors.

### CROSS-REFERENCE TO RELATED APPLICATIONS

This application claims the benefit of U.S. Provisional Patent Application Ser. No. 60/822,792 filed Aug. 18, 2006, and (a) is a continuation-in-part of U.S. patent application Ser. No. 11/420,207, filed May 24, 2006, (which claims the benefit of U.S. Provisional Patent Application Ser. No. 60/684,415 filed May 24, 2005), which is a continuation-in-part of U.S. patent application Ser. No. 11/297,041 filed Dec. 7, 2005 (which claims the benefit of U.S. Provisional Application Ser. No. 60/634,495 filed Dec. 8, 2004), which is a continuation-in-part of U.S. patent application Ser. No. 11/015,185 filed Dec. 17, 2004 (which claims the benefit of 60/531,458 filed Dec. 18, 2003); (b) and is a continuation-in-part of U.S. patent application Ser. No. 11/354,583 filed Feb. 14, 2006 (which claims the benefit of U.S. Provisional Application Ser. No. 60/652,922 filed Feb. 14, 2005); (c) is a continuation-in-part of U.S. patent application Ser. No. 10/910,810 filed Aug. 3, 2004; and (d) is a continuation-in-part of U.S. patent application Ser. No. 11/342,240 filed Jan. 27, 2006, (which claims the benefit of U.S. Provisional Patent Application Ser. No. 60/648,327 filed Jan. 27, 2005), which is a continuation-in-part of U.S. patent application Ser. No. 11/225,607 filed Sep. 12, 2005 (which claims priority from U.S. Provisional Patent Application Ser. No. 60/608,582 filed Sep. 10, 2004), which is a continuation-in-part of U.S. patent application Ser. No. 11/166,008 filed Jun. 24, 2005, which is (i) a continuation of U.S. patent application Ser. No. 09/631,892 filed Aug. 14, 2000, now U.S. Pat. No. 6,972,312 (which claims priority from U.S. Provisional Patent Application Ser. No. 60/147,435, filed Aug. 4, 1999); (ii) a continuation of U.S. patent application Ser. No. 10/351,292, filed Jan. 23, 2003, now U.S. Pat. No. 6,933,345 (which claims priority from U.S. Provisional Patent Application Ser. No. 60/351,523, filed Jan. 23, 2002), which is a continuation-in-part of U.S. patent application Ser. No. 09/818,265, filed Mar. 26, 2001, now U.S. Pat. No. 6,716,919 (which claims priority from U.S. Provisional Patent Application Ser. No. 60/192,083, filed Mar. 24, 2000); (iii) a continuation of U.S. patent application Ser. No. 09/747,762, filed Dec. 21, 2000, now U.S. Pat. No. 6,911,518 (which claims priority from U.S. Provisional Patent Application Ser. No. 60/171,888, filed Dec. 23, 1999); and (iv) a continuation of U.S. patent application Ser. No. 10/186,318, filed Jun. 27, 2002, now U.S. Pat. No. 6,927,270 (which claims priority from U.S. Provisional Patent Application Ser. No. 60/147,435, filed Jun. 27, 2001). The disclosures of the foregoing applications are incorporated herein by reference.

### BACKGROUND OF THE INVENTION

1. Field of the Invention

The present invention relates to protecting solders joints (including lead-free solders) against short circuiting via the formation of conductive whiskers. The invention also provides a method for rendering the solder joint hydrophobic and resistant against corrosive damage from moisture.

2. Description of the Prior Art

This invention relates to the use of polyhedral oligomeric silsesquioxane, silsesquioxane, polyhedral oligomeric silicate, silicates, and silicones or metallized-polyhedral oligomeric silsesquioxane, silsesquioxane, polyhedral oligomeric silicate, silicates, and silicones in solder coatings. Polyhedral oligomeric silsesquioxane, silsesquioxane, polyhedral oligomeric silicate, silicates, and silicones, and metallized-polyhedral oligomeric silsesquioxane, silsesquioxane, polyhedral oligomeric silicate, silicates, and silicones are hereinafter referred to as “silicon containing agents.”

Silicon containing agents have previously been utilized to complex metal atom(s) and for the dispersion of nanoscopic entities. As discussed by Gilman et al., 60 J. Appl. Poly. Sci 591 (1996); Phillips et al. 37 J. Spacecraft and Rockets 463 (2000), silicon containing agents can be converted in the presence of atomic oxygen to form a glass like silica layer. Thiol-functionalized silicon containing agents have also been utilized to modify silver surfaces to render them more resistant to environmental degradation and aid their utility as sensors and for protective encapsulation, and as coatings on electroluminescent semiconductors to increase their light emission as described in U.S. Pat. No. 7,227,305.

U.S. patent application Ser. No. 10/910,810 (“Composite Metal Matrix Castings and Solder Compositions”) and U.S. patent application Ser. No. 11/342,240 (“Surface Modification With POSS Silanols”), the disclosures of which are incorporated herein by reference, describe silicon containing agents as useful for the modification of metallic surfaces. U.S. Pat. No. 5,585,544, also incorporated herein by reference, describes the use of silicon containing agents (referred to as spherosiloxanes) as hydrophobic agents on metals for corrosion prevention.

With ongoing concern regarding environmental pollutants, leaded solders have been targeted for elimination from electronic assemblies. However, lead-free solders are well known to spontaneously form electrically conductive tin whiskers that create short circuits at the surfaces of solder joints, and pose reliability issues for their use in long-term service applications such as aircraft, autos, missiles, satellites, appliances, and microelectronics. A solution is needed to ensure their reliability at the original equipment manufacture and service-maintenance levels.

### SUMMARY OF THE INVENTION

It has surprisingly been discovered that silicon containing agents are useful for the retrofitting of electronic components which utilize any of a number of conductive or semiconductive materials, including solders which are also subject to short circuiting via the formation of metallic whiskers or atomistic migration at or between layers, joints, and material interfaces.

In such capacity the silicon containing agents are themselves effective when applied in either a monomeric or polymeric form directly onto the solder joint, semiconductor or interconnect. The nanoscopic silicon containing agents also provide an exceptional moisture barrier, electrically insulative properties, and control the surface of material interfaces to prevent growth of metallic whiskers and atom migration.

Advantages of the present invention include that it is nondetectable by the human eye; can be applied by chemical adhesion to the solder joint, conductor or semiconductor; low cost spray or paint-on application to circuit boards, chip assemblies, solar cells, and internal chip components; nonconductivity; and improved hydrophobicity.

Nanoscopic caged chemicals do not outgas and can create a nanoscopically thin bonded coating over preassembled solder joints and board assemblies without requiring reassemble or board rework. These properties and performance assurance are useful in a number of applications including rockets, space vehicles, solar cells, terrestrial vehicles, appliances, and microelectronics. The silicon containing agents of most utility in this work are best exemplified by those based on low cost silicones, silsesquioxanes, polyhedral oligomeric silsesquioxanes, and polyhedral oligomeric silicates. FIG. 1 illustrates some representative examples of silicon containing agents with siloxane, silsesquioxane, and silicate structures. The R groups in such structures can range from H, to alkane, alkene, alkyne, aromatic and substituted organic systems including ethers, acids, amines, thiols, phosphates, and halogenated and fluorinated groups.

The preferred silicon containing agents for this invention all share a common hybrid (i.e. organic-inorganic) composition in which the internal framework cage is primarily comprised of inorganic silicon-oxygen bonds. The exterior cage of these nanostructures is covered by both reactive and nonreactive organic functionalities (R), which ensure compatibility, film formation and tailorability of the nanostructure and the coated surface. These and other properties of nanostructured chemicals are discussed in detail in U.S. Pat. No. 5,412,053 and U.S. Pat. No. 5,484,867, both of which are incorporated herein by reference. These nanostructured chemicals are of low density, and can range in diameter from 0.5 nm to 5.0 nm.

### BRIEF DESCRIPTION OF THE DRAWINGS

FIG. 1 shows representative structural examples of nonmetallized silicon containing agents.

FIG. 2 illustrates preferred structures for silanol cages

FIG. 3 illustrates preferred structures for thiol functionalized cages.

FIG. 4 illustrates preferred structures for silane functionalized cages.

FIG. 5 is a plot of whisker index versus time for three different strain levels.

FIG. 6 illustrates solder surface modification at the grain boundary level.

### DEFINITION OF FORMULA REPRESENTATIONS FOR NANOSTRUCTURES

For the purposes of understanding this invention's chemical compositions the following definition for formula representations of silicon containing agents and in particular Polyhedral Oligomeric Silsesquioxane (POSS) and Polyhedral Oligomeric Silicate (POS) nanostructures is made.

Polysilsesquioxanes are materials represented by the formula [RSiO_{1.5}]_{∞} where ∞ represents molar degree of polymerization and R=represents organic substituent (H, siloxy, cyclic or linear aliphatic or aromatic groups that may additionally contain reactive functionalities such as silanols, thiols, hydrides, alcohols, esters, acids, amines, ketones, olefins, ethers or which may contain halogens). Polysilsesquioxanes may be either homoleptic or heteroleptic. Homoleptic systems contain only one type of R group while heteroleptic systems contain more than one type of R group.

A subset of silicon containing agents are classified as POSS and POS nanostructure compositions are represented by the formula:

[(RSiO_{1.5})ₙ]_{Σ#} for homoleptic compositions

[(RSiO_{1.5})ₙ(R′SiO_{1.5})ₘ]_{Σ#} for heteroleptic compositions (where R≠R′)

[(RSiO_{1.5})ₙ(RSiO_{1.0})ₘ(M)ⱼ]_{Σ#} for heterofunctionalized heteroleptic compositions

[(RSiO_{1.5})ₙ(RXSiO_{1.0})ₘ]_{Σ#} for functionalized heteroleptic compositions (where R groups can be equivalent or inequivalent)

In all of the above R is the same as defined above and X includes but is not limited to OH, Cl, Br, I, alkoxide (OR), acetate (OOCR), peroxide (OOR), amine (NR₂) isocyanate (NCO), and R. The symbol M refers to metallic elements within the composition that include high and low Z metals and in particular Al, B, Ga, Gd, Ce, W, Ni, Eu, Y, Zn, Mn, Os, Ir, Ta, Cd, Cu, Ag, V, As, Tb, In, Ba, Ti, Sm, Sr, Pb, Lu, Cs, Tl, Te. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

### DETAILED DESCRIPTION OF THE INVENTION

The present invention teaches the use of nanoscopic silicon containing agents as assurance coatings and agents for the mitigation of whisker formation, atom migration, and environmental aging of solder joints and semiconductors, and for protecting electronic assemblies from short circuiting due to whisker formation between solder, semiconductor and related electrical connections. The keys that enable nanostructured chemicals such as silicon containing agents to function in this capacity include: (1) their unique size, high surface areas, and ability to coat a surface; (2) their ability to be uniformly dispersed at the nanoscopic level and promote surface compatibility; (3) their ability to chemically incorporate metals into the cage, (4) their inherent dielectric properties; and (5) the ability of the cage to behave as a sprayable coating.

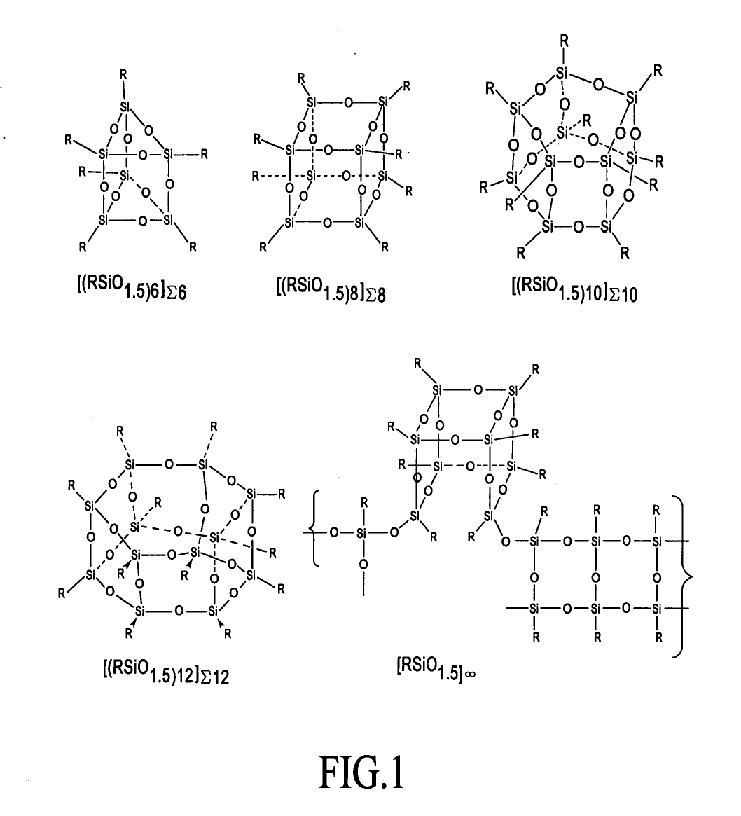

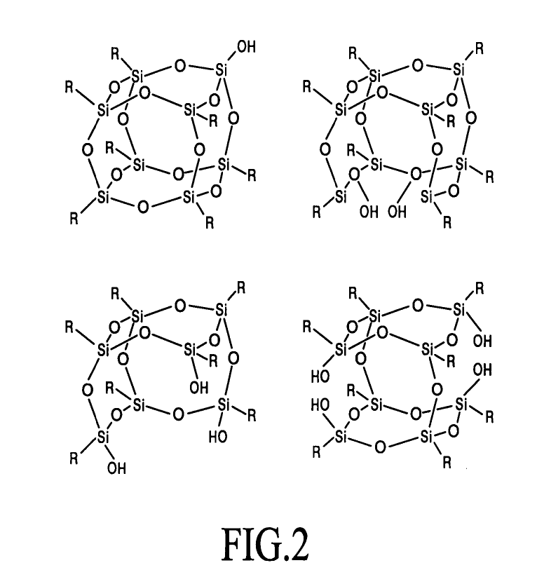

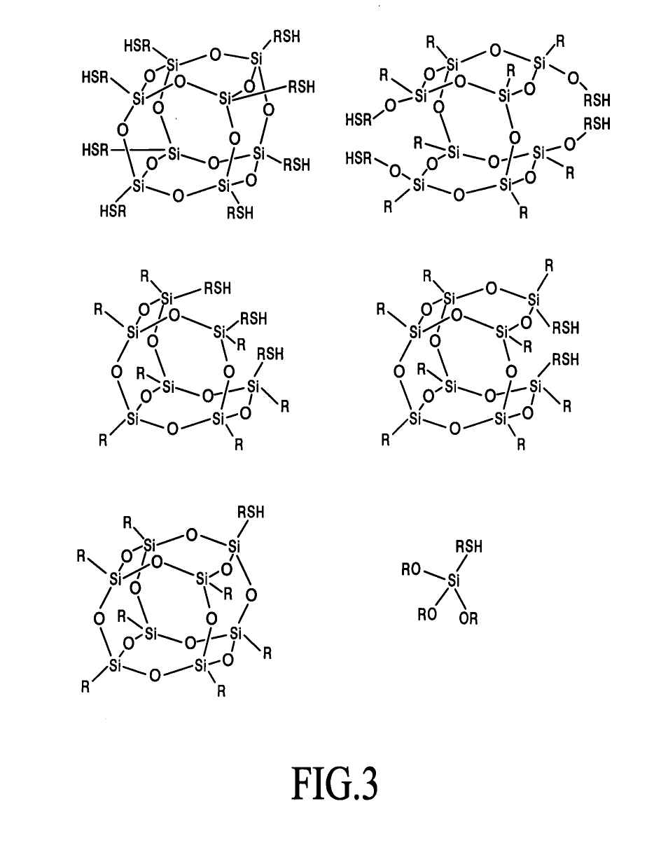

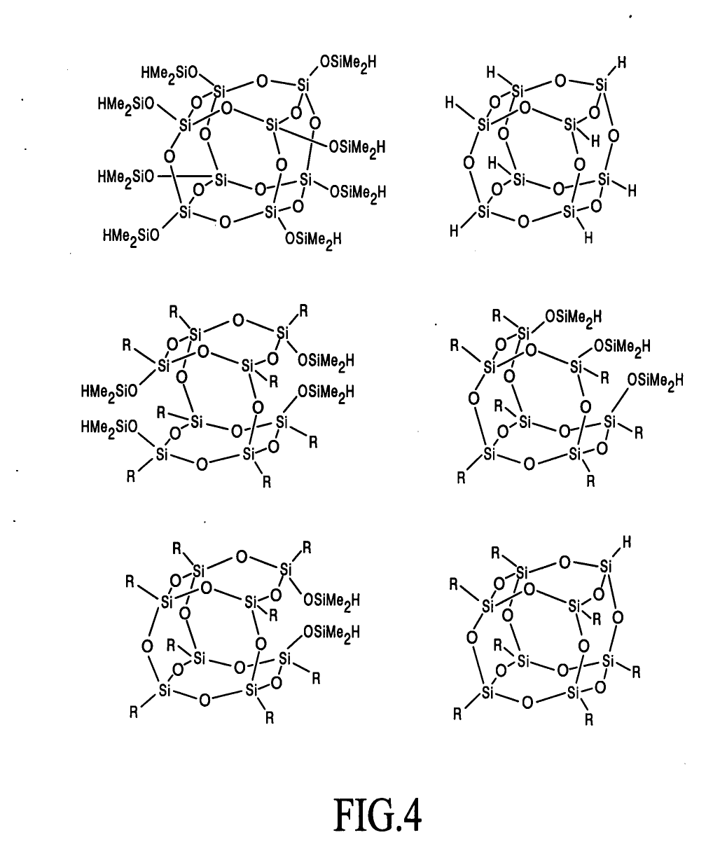

Preferably among nanonostructured chemicals are silicon containing agents, such as the polyhedral oligomeric silsesquioxanes (POSS) illustrated in FIG. 1. Preferred compositions include silicon containing agents bearing reactive silanol (FIG. 2), thiol (FIG. 3), and silane (FIG. 4) functionalities. These functionalities are desired because their interaction with the metals contained in semiconductors and solders is thermodynamically favored, rendering them highly effective. They are available as solids and oils, and with or without metals. Both forms dissolve in solvent, monomers, and polymers, which are desirable carriers for the agents. For POSS, dispersion appears to be thermodynamically governed by the free energy of mixing equation (ΔG=ΔH−TΔS). The nature of the R group and ability of the reactive groups on the POSS cage to react or interact with polymers and surfaces greatly contributes to a favorable enthalpic (ΔH) term while the entropic term (ΔS) is highly favorable because of the monoscopic cage size and distribution of 1.0.

Furthermore, because silicon containing agents like POSS nanostructured chemicals possess spherical shapes (per single crystal X-ray diffraction studies), like molecular spheres, and because they dissolve, they are also effective at reducing the viscosity of polymer systems rendering sprayable and paintable coatings. Silicon containing agents such as POSS silanes are also vapor depositable onto a metallic surface.

An approach that solves the whisker formation issue for lead-free solders and that can be affordably retro-applied to existing solder connections is to spray-apply or paint a coating of nanoscopic silicon containing agents over the entire electronic assembly, thereby protecting it from whisker formation.

When applied to solder joints as a retrofit to circuit boards containing lead-free solders, silicon containing agents such as polyhedral oligomeric silsesquioxanes (POSS) have several significant advantages. POSS nanobuilding blocks are optically transparent materials, electrically nonconductive, provide increased hydrophobicity, corrosion resistance and control the surface grain of the solder to mitigate whisker growth. Further, upon oxidation these systems readily form silica glasses. Silicon containing agents have been applied to solder connections by brush, spray, dip, and vapor deposition. Thus, the ability to retrofit an already assembled circuit board at low cost provides assurance against component failure due to instability of the lead-free solder joints.

The preferred compositions presented herein contain two primary material combinations: (1) silicon containing agents including nanostructured chemicals, nanostructured oligomers, or nanostructured polymers from the chemical classes of silicones, polyhedral oligomeric silsesquioxanes, polysilsesquioxanes, polyhedral oligomeric silicates, polysilicates spherosilicates; and (2) manmade polymer systems or delivery agents including solvents such as hydrocarbons, chlorinated and fluorinated hydrocarbons; supercritical fluids; and polymeric and polymerizable carriers.

Preferably, the method of incorporating the nanostructured chemicals onto a surface can be accomplished through vapor deposition, spraying, dipping, painting, brushing, powder coating, or spin coating and may utilize solvent assisted methods.

Of key importance is the use of a silicon containing agent with a chemical ability to bond to metallic surfaces. Therefore reactive groups such as silanols, silanes, thiols, phosphines, amines, alcohols, ethers, acids, esters, are preferred and desirable. Because of their chemical nature, silicon containing agents can be tailored to contain more than one type of such reactive group. Similarly, the compatibility of silicon containing agents with surfaces can be controlled through altering the type and number of reactive groups on the nanoscopic cage.

### EXAMPLES

### General Process Variables Applicable to All Processes

As is typical with all chemical processes there are a number of variables that can be used to control the purity, selectivity, rate, mechanism and economics of any process. Variables influencing the process for the use nanostructured chemicals and especially of silicon containing agents as effective coatings for lead free solders include the size, polydispersity, and composition of the nanoscopic agent. Similarly the molecular weight, polydispersity and composition of the polymer system or type of solvent that may also be utilized can also be tailored to meet requirements. Blending processes such as melt blending, dry blending and solution mixing blending are all effective at mixing and alloying nanoscopic silica agents into a coating with desirable properties.

Nanostructured chemicals can also be added to a vessel containing the desired polymer, prepolymer or monomers and dissolved in a sufficient amount of an organic solvent (e.g. hexane, toluene, dichloromethane, etc.) or fluorinated solvent to effect the formation of one homogeneous phase. The mixture is then stirred under high shear at sufficient temperature to ensure adequate mixing, and the volatile solvent is then removed and recovered under vacuum or using a similar type of process including distillation. Note that supercritical fluids such as CO₂ can also be utilized as a replacement for the flammable hydrocarbon solvents. The resulting formulation may then be used directly or for subsequent processing.

### Example 1

### Mitigation of Tin Whiskers

In an effort to evaluate the effectiveness of POSS coatings on whisker growth, mane Sn surfaces were utilized. Mane Sn surfaces on copper were created using immersion plating. The mane Sn coated Cu strips were bent to a fixed radius to create a compressive deformation. Three different curvatures were used: 1.31; 3.16; and 15.96 mm. The copper strip had a dimension of 25 mm×10 mm×0.5 mm, the bending radius corresponds to outer fiber strains of 1.5%, 7.2% and 16.1%, respectively.

Quantitative evaluation of the whisker growth was made using a parameter known as Whisker Index (WI), and has been described by Xu, et al., IPC SMEMA APEX Conference, Jan. 19, 2002, pp. 506-2.1 to 506-2.6. This method assigns weight factors depending on the length of the whisker, based on the criticality for chosen line spacing. The weight factors used in this study, based on 100 mm line spacing, are ‘0’ and ‘100’ for whiskers of length less than 5 μm and greater than 50 μm, respectively. Whiskers with lengths between 5 to 10 μm, and 10 to 50 μm, are assigned weight factors of ‘1’ and ‘10’, respectively. Using this scheme, WI=Σ (number of whiskers in each category)×(weight factor for the category).

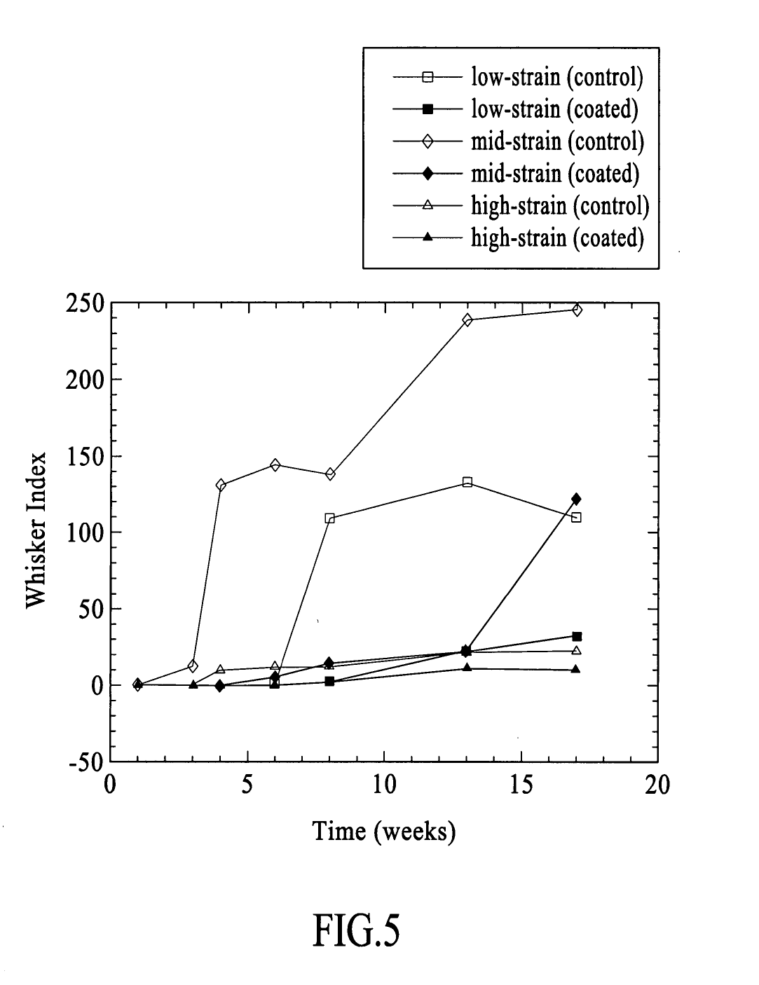

FIG. 5 shows a plot of whisker index versus time (in weeks). It was observed that whisker growth does require a compressive deformation, as no whiskers were observed on the tensile-side of all the bent specimens evaluated. Comparison of the whisker index for the control matte Sn to the matte Sn coated with POSS reveals that the time needed for initial whisker growth was extended by a factor of 4. Further, the thickness of whiskers was observed to be thinner by a factor of 2. Therefore, under appropriate stain conditions whisker growth could be mitigated or greatly slowed via the application of such silicon containing agents.

Since the whisker growth and atom migration are postulated to be a form of stress-relief, the effect of silicon containing agents bearing mono and polyfunctional groups was evaluated. In all cases, cages bearing polyfunctionality were more effective at mitigation than monofunctional systems. However, monofunctional cages were effective at providing mitigation and enhanced hydrophobicity of the surface. Surface hydrophobicity and whisker mitigation are desirable for non-hermitic environments.

### Example 2

### Coating of Preformed Solder Joints

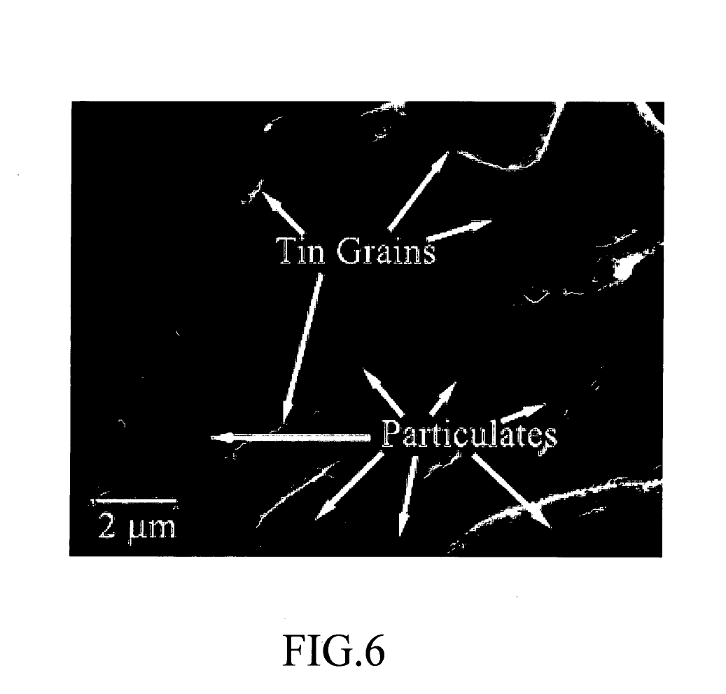

In an effort to evaluate the effectiveness of POSS coatings on binding to solder surfaces, leaded solders, silver-tin, and silver-tin-copper solders were coated with POSS silanols, POSS thiols and POSS silanes. Both solution dipping and spray techniques were used to apply the POSS. The surfaces were then washed and examined using electron microscopy. FIG. 6 shows the deposition of POSS cages within the solder grain. This verifies the ability of the cage to access the grain boundary of solders. It is recognized that all solders contain an oxide layer and this oxide layer is known to be reactive toward protonation. Hence, it is necessary to utilize cages bearing reactive groups to protonate through the surface oxides in order to form metal-sulfur, metal-oxygen, and metal-silicon bonds to the POSS cage. The reactivity of cages bearing thiols or silanols were found to be more effective than cages bearing silane (hydride) functionality.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for protecting an electronic assembly, comprising the steps of:
(a) mixing a silicon containing agent with a carrier to form a coating mixture; and
(b) creating a protective coating by coating the electronic assembly with the coating mixture.

2. The method of claim 1, wherein the silicon containing agent is selected from the group consisting of nanostructured silicones, polyhedral oligomeric silsesquioxanes, polyhedral oligomeric silicates, polysilicates, and sphereosilicates.

3. The method of claim 1, wherein the carrier is selected from the group consisting of polymers, hydrocarbons, chlorinated hydrocarbons, fluorinated hydrocarbons, supercritical fluids, and polymerizable materials.

4. The method of claim 2, wherein the carrier is selected from the group consisting of polymers, hydrocarbons, chlorinated hydrocarbons, fluorinated hydrocarbons, supercritical fluids, and polymerizable materials.

5. The method of claim 4, wherein the silicon containing agent includes a functional group selected from the group consisting of thiols, silanols, and silanes.

6. The method of claim 5, wherein the silicon containing agent is selected from the group consisting of POSS and POS.

7. The method of claim 5, wherein the electronic assembly includes a lead-free solder, and the protective coating inhibits the formation of conductive metal whiskers or atom migration.

8. The method of claim 5, wherein the protective coating increases hydrophobicity.

9. The method of claim 5, wherein the protective coating is applied by a method selected from the group consisting of spraying, painting, dipping, or vapor deposition.

10. The method of claim 1, wherein the mixing is nonreactive.

11. The method of claim 1, wherein the mixing is reactive.

12. An electronic assembly comprising:
(a) an electronic component having at least one lead-free solder connection; and
(b) a coating for the connection including a silicon containing agent selected from the group consisting of nanostructured silicones, polyhedral oligomeric silsesquioxanes, polyhedral oligomeric silicates, polysilicates, and sphereosilicates.

13. The electronic assembly of claim 12, wherein the coating is applied with a carrier selected from the group consisting of polymers, hydrocarbons, supercritical fluids, and polymerizable materials.

14. The electronic assembly of claim 12, wherein the coating includes a polymer.

15. The electronic assembly of claim 12, wherein the silicon containing agent includes a functional group selected from the group consisting of thiols, silanols, and silanes.

16. The electronic assembly of claim 12, wherein the silicon containing agent is selected from the group consisting of POSS and POS.

17. The electronic assembly of claim 12, wherein the coating inhibits the formation of conductive metal whiskers or atom migration.

18. The electronic assembly of claim 12, wherein the coating increases hydrophobicity.

19. The electronic assembly of claim 12, wherein the coating is applied by a method selected from the group consisting of spraying, painting, dipping, or vapor deposition.

20. The electronic assembly of claim 13, wherein the carrier and the silicon containing agent are nonreactively mixed.
